(19) United States
(12) Patent Application Publication
(10) Pub. No.: US 2015/0286929 A1
(43) Pub. Date: Oct. 8, 2015

(54) AGGREGATION AND CORRELATION OF DATA FOR LIFE MANAGEMENT PURPOSES

(71) Applicant: STATE FARM MUTUAL AUTOMOBILE INSURANCE COMPANY, Bloomington, IL (US)

(72) Inventors: John Henry Weekes, Bloomington, IL (US); Abigail Rachel Tohline, Bloomington, IL (US); Jonathan Darius Maurer, Bloomington, IL (US); Joseph Harr, Bloomington, IL (US); Andrew Joseph Phillips, Bloomington, IL (US); Michael Jeffrey Aviles, Bloomington, IL (US); Daryoush Hakimi, Bloomington, IL (US); Robert Louis Hembra, Bloomington, IL (US)

(73) Assignee: STATE FARM MUTUAL AUTOMOBILE INSURANCE COMPANY, Bloomington, IL (US)

(21) Appl. No.: 14/245,839

(22) Filed: Apr. 4, 2014

(51) Int. Cl. G06N 5/02

(52) U.S. Cl. CPC G06N 5/022

(57) ABSTRACT

A method and computer system aggregates and correlates various types of data from an individual for life management purposes. As an example, the various types of data may include home data, vehicle data, and personal health data associated with the individual. The method and system may receive the various types of data from the individual and analyze each type of data to determine patterns associated with each type of data. The method and system may then compare each of the determined patterns with one another to determine any underlying factors and correlations that may be affecting each of the determined patterns. Based on the determined underlying factors and correlations for each of the determined patterns, the method and system may provide the individual with various benefits such as personalized recommendations, insurance discounts, and other added values or services that the individual can use to better manage and improve his or her life.

### TECHNICAL FIELD

The present application relates generally to life management and, more specifically, to systems and methods for aggregating and correlating various types of data from an individual for the purpose of managing and improving the individual's life.

### BACKGROUND

Today, people have numerous sources of information that they rely on to manage various aspects of their lives, such as their residence, vehicle, health, finances, etc. To access all the information, people usually interact with different companies that provide the products or services that they need, visit many different web sites, or use different software programs for each of the products or services that they own. However, by gathering and maintaining information from many disparate sources, the process in which people try to manage their lives can become rather complicated and tiresome.

In recent years, a number of different self-monitoring programs have been developed that enable individuals to manage their lives by monitoring their personal activities or data. For example, self-monitoring programs may allow an individual to monitor and get information about his or her health activities (e.g., diet, exercise, etc.), financial activities (e.g., savings, investment, etc.), home activities (e.g., energy use, maintenance and repair, etc.), etc. However, most of these programs are focused primarily on providing the individual with the ability to track and view his or her personal activities or data, and thus do not identify relevant underlying factors that may be associated with certain activities which in turn may affect particular aspects of the individual's life. As a result, most of these programs do not provide an adequate solution as to how the individual can better manage or improve his or her life based on the tracking of personal activities or data.

### SUMMARY

The features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

A computer-implemented method of aggregating and correlating data may include receiving, via one or more processors, a set of different types of data from an individual. The received set of different types of data may include one or more of home data, vehicle data, personal health data, or finance data. The method may also analyze, via one or more processors, each type of data in the set to determine one or more patterns for each type of data. Further, the method may compare, via one or more processors, each of the one or more patterns determined for each type of data in the set with one another to determine one or more underlying factors associated with each of the determined patterns. The method may then provide, via one or more processors, recommendations to the individual for each of the determined patterns based on the determined underlying factors for each of the determined patterns.

A non-transitory computer-readable storage medium may comprise computer-readable instructions to be executed on one or more processors of a system for aggregating and correlating data from an individual. The instructions when executed, may cause the one or more processors to receive a set of different types of data from an individual. The received set of different types of data may include one or more of home data, vehicle data, personal health data, finance data, personal calendar data, or online activity data. The instructions when executed, may also cause the one or more processors to analyze each type of data in the set to determine one or more patterns for each type of data. Further, the instructions when executed, may cause the one or more processors to compare each of the one or more patterns determined for each type of data in the set with one another to determine one or more underlying factors associated with each of the determined patterns. The instructions when executed, may then cause the one or more processors to provide recommendations to the individual for each of the determined patterns based on the determined underlying factors for each of the determined patterns.

A computer system for aggregating and correlating data from an individual may comprise a plurality of data repositories where each data repository stores a different type of data from the individual, a data pattern repository, and a data server that includes a memory having instructions for execution on one or more processors. The instructions when executed by the one or more processors, may cause the data server to receive a set of different types of data from the plurality of data repositories. The received set of different types of data may include one or more of home data, vehicle data, personal health data, or finance data. The instructions when executed by the one or more processors, may also analyze each type of data in the set to determine one or more patterns for each type of data. The instructions when executed by the one or more processors, may store each of the determined patterns in the data pattern repository. Further, the instructions when executed by the one or more processors, may compare each of the one or more patterns determined for each type of data in the set with one another to determine one or more underlying factors associated with each of the determined patterns. The instructions when executed by the one or more processors, may then provide, via a network connection, recommendations to the individual for each of the determined patterns based on the determined underlying factors for each of the determined patterns. Finally, the instructions when executed by the one or more processors, may display, via a network connection, the recommendations to the individual.

### BRIEF DESCRIPTION OF THE DRAWINGS

FIG. 1 is a block diagram of an example system for aggregating and correlating various types of data from an individual for life management purposes.

FIG. 2 is a flow diagram of an example method for aggregating and correlating various types of data from an individual for life management purposes.

FIG. 3 is a block diagram of a computing environment that implements a system and method for aggregating and correlating various types of data from an individual for life management purposes.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Generally speaking, the disclosed system aggregates and correlates data associated with an individual in order to provide the individual with customized information, helpful insights and personalized recommendations that the individual can use to better manage and improve his or her life. As described herein, the disclosed system aggregates and correlates home data, vehicle data, and personal health data from the individual. In general, however, the disclosed system may aggregate and correlate any and all types of data associated with the individual, examples of which may include, but not limited to, finance data, online activity data, personal calendar data, etc.

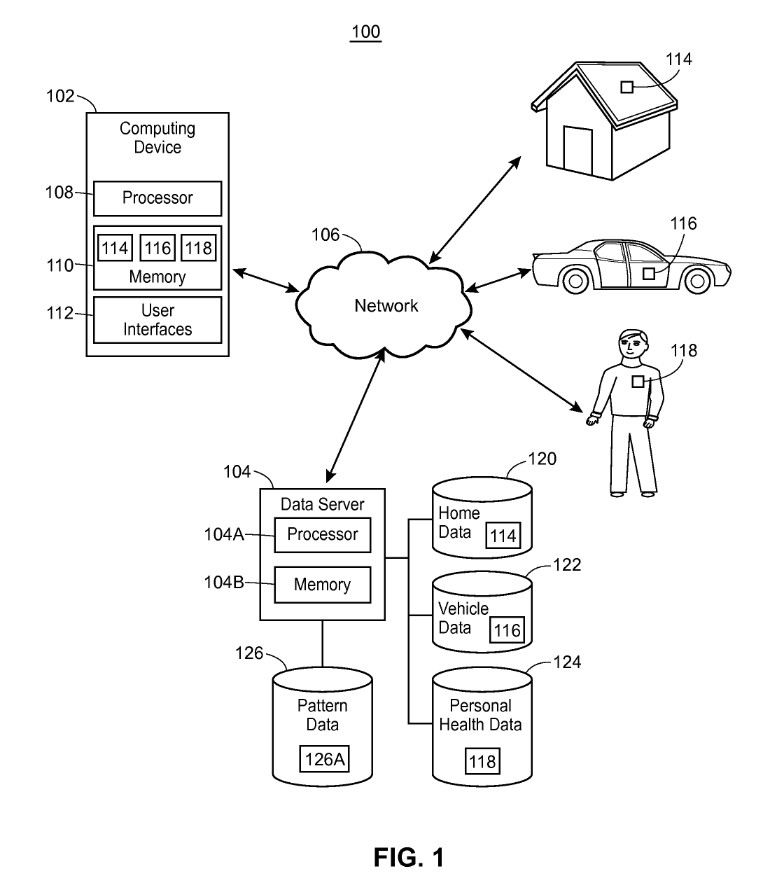

FIG. 1 is a block diagram of an example system 100 for aggregating and correlating various types of data from an individual. The example system 100 includes a computing device 102 that is communicatively coupled to a data server 104 via a network 106 (e.g., a local area network, a wide area network, a mobile network, a wired or wireless network, a private network, etc.). The computing device 102 may include a processor 108, a memory 110, and user interfaces 112 (e.g., a display screen, a touchscreen, a keyboard, an analog control panel, etc.). In general, the computing device 102 may be a personal computer, a smart phone, a tablet computer, etc.

As shown in the embodiment of FIG. 1, aggregating the various types of data from the individual may include, for example, collecting, parsing, grouping and summing the individual's home data 114, vehicle data 116, and personal health data 118.

The home data 114 may be generated from any number of home sensors (not shown in FIG. 1) located at the individual's place of residence. For example, the home sensors may include utility meter sensors (e.g., water sensors, gas sensors, electricity sensors, etc.) that generate data indicating utility or energy usage. As another example, the home sensors may include sensors embedded in smart appliances that generate data relating to the operation of the smart appliances (e.g., sensors in a smart refrigerator may indicate the temperature settings and how often the water filter is changed). As yet another example, the home sensors may include various types of sensors found around the interior and exterior of the residence (e.g., smoke detectors, water leak detectors, humidity sensors, garage door sensors, outdoor movement sensors, etc.) that generate data indicating conditions both inside and outside of the home. As a further example, the home sensors may include sensors or devices in a home automation and monitoring system that generate data relating to the control and/or automation of the home (e.g., light level settings, home alarm settings, thermostat settings, etc.).

Similarly, the vehicle data 116 may be generated from any number of vehicle sensors (not shown in FIG. 1) located in the individual's vehicle. For example, the vehicle sensors may include sensors that generate data indicating the physical and/or mental conditions of the driver (e.g., indicators that show the driver's cognitive load, the driver's eye movement, the driver's reaction time, etc.). Additionally, the vehicle sensors may include sensors that generate data indicating the driving environment (e.g., sensors that measure road surface conditions, noise levels inside the vehicle cabin, traffic densities around the vehicle, etc.). Further, the vehicle sensors may include sensors that generate data indicating the driver's interactions with the vehicle (e.g., sensors that measure the driver's following and closing distance, the driver's response to safety warning systems, etc.).

Finally, the personal health data 118 may be generated from any number of wearable, implantable, ingestible, or hand-held personal health sensors (not shown in FIG. 1) that the individual is using. As an example, the personal health sensors may include sensors that generate data indicating the individual's various physiological parameters (e.g., heart rate monitors that measure the individual's heart rate, blood pressure monitors that show the individual's blood pressure level, sleep pattern monitors that measure the individual's sleep patterns, etc.). As another example, the personal health sensors may include sensors that generate data related to the various fitness activities carried out by the individual (e.g., pedometers or electronic fitness bracelets that measure the individual's daily exercises such as walking, running, biking, etc.).

As noted earlier, the various types of data collected from the individual are not necessarily limited to the data types shown in FIG. 1. In other embodiments and/or scenarios, other types of data associated with the individual (e.g., finance data, online activity data, personal calendar data, etc.) may be aggregated and correlated along with the home data 114, the vehicle data 116 and the personal health data 118.

The home data 114, the vehicle data 116 and the personal health data 118 may be gathered and aggregated in the memory 110 before being transmitted to the data server 104 via the network 106. In some embodiments, the data may be transmitted directly to the data server 104 via the network 106 for aggregation and storage. Moreover, the home data 114, the vehicle data 116 and the personal health data 118 may only be gathered and aggregated with an individual's full understanding and acceptance of published terms and conditions for collection and use of those data. For example, before the computing device 102 can execute instructions to collect or process data, a visual or other prompt at the computing device 102 may alert the individual to such action. Thus, the prompt allows the individual to “opt out” of some or all collection of the home data 114, the vehicle data 116 and the personal health data 118, or any other types of data as described herein.

In some embodiments, some or all of the home data 114, vehicle data 116 and personal health data 118 may be sent to the data server 104 via a third party. For example, a server of a datahub provider (not shown in FIG. 1) may first store and then transmit the home data 114, vehicle data 116 and personal health data 118 to the data server 104 via the network 106 or a different network.

With continued reference to FIG. 1, the data server 104 may be a single server or a plurality of servers with distributed processing. The data server 104 may be coupled to a home data repository 120, a vehicle data repository 122, a personal health data repository 124, and a pattern data repository 126. In an embodiment, the data server 104 may, at the individual's option and understanding, receive the aggregated home data 114, the vehicle data 116 and the personal health data 118 stored in the memory 110 via the network 106. The data server 104 may operate directly on the home data 114 provided in the home data repository 120, the vehicle data 116 provided in the vehicle data repository 122, and the personal health data 118 provided in the personal health data repository 124. Alternatively or additionally, the data server 104 may operate on other data generated based on the home data 114 from the home data repository 120, the vehicle data 116 from the vehicle data repository 122, and the personal health data 118 from the personal health data repository 124. For example, the data server 104 may convert the home data 114 in the repository 120, the vehicle data 116 in the repository 122 and/or the personal health data 118 in the repository 124 to a particular format (e.g., for efficient storage), and later utilize or operate on the modified data.

A processor 104A of the data server 104 may execute instructions stored in a memory 104B of the data server 104 to retrieve data stored in the data repositories 120, 122, 124 and 126. In some embodiments, the data repositories 120, 122, 124 and/or 126 may not be directly coupled to the data server 104, but instead may be accessible by the data server 104 via a network such as the network 106.

The data server 104 may be configured to correlate the home data 114, the vehicle data 116 and the personal health data 118 to discover relevant underlying factors in order to provide the individual with information and recommendations that the individual can use to better manage and improve his or her life. To do so, the data server 104 analyzes each data type to determine one or more data patterns associated with each of the home data 114, the vehicle data 116 and the personal health data 118. The determined data patterns are stored as pattern data 126A in the pattern data repository 126. The data server 104 may access the pattern data 126A to determine underlying factors and correlations that may be affecting the discovered patterns. Based on the determined underlying factors and correlations, the data server 104 may then provide the individual with helpful information and recommendations.

In some embodiments, the home data 114, the vehicle data 116, the personal health data 118, and the pattern data 126A may be stored in a single data repository as big data. The data server 104 may then access the single data repository to process, analyze and correlate the big data in any of the manners described herein.

In an example embodiment, the data server 104 may analyze the vehicle data 116 and determine a driver behavioral pattern, which indicates that the individual frequently feels irritated while driving. The determined driver behavioral pattern may be stored as part of the pattern data 126A. To discover the underlying factors for this driver behavioral pattern, the data server 104 may compare the driver behavioral pattern to other patterns determined from analyzing other data such as the home data 114 and the personal health data 118. These other patterns may also be stored as part of the pattern data 126A. For example, the data server 104 may determine a sleeping pattern from the personal health data 118, which indicates that the individual is not sleeping well or not getting enough sleep at night. Thus, by comparing the determined driver behavioral pattern and the sleeping pattern, the data server 104 may determine that a possible underlying factor for the individual's irritated feeling while driving may be a lack of proper sleep, which is interfering with the individual's overall mood. Based on this correlation, the data server 104 may recommend that the individual adhere to a more regulated sleeping schedule (e.g., recommending the individual to set up a bedtime alarm every night, alerting the individual of a proper time to sleep every night through a text message, etc.). Furthermore, the data server 104 may determine a home setting pattern from analyzing the home data 114, which indicates that the temperature in the individual's home is cooler than normal. The cooler temperature may be causing the individual to wake up frequently at night, and thus contributing to the fact that the individual is not sleeping well. Accordingly, comparison of the determined driver behavioral pattern and the home setting pattern reveals that the temperature setting in the individual's home may be a possible underlying factor for the individual's poor sleep, which in turn is affecting the individual's overall mood. Based on this further correlation, the data server 104 may also recommend or notify the individual to adjust the temperature setting in his or her home.

In another example embodiment, the data server 104 may analyze the personal health data 118 and determine a stress pattern, which indicates that the individual's general stress level is increasing. This stress pattern may be stored as part of the pattern data 126A. To uncover the underlying factors for this stress pattern, the data server 104 may compare the stress pattern to other patterns determined from analyzing other data such as the home data 114 and the vehicle data 116. These other patterns may also be stored as part of the pattern data 126A. For example, the data server 104 may determine a driving pattern from the vehicle data 116, which indicates that the individual is often stuck in traffic during the daily commute to work. By comparing the determined stress pattern and the driving pattern, the data server 104 may determine that a possible underlying factor for the individual's increase in stress may be the frustration that the individual feels everyday when stuck in traffic. Thus, based on this correlation, the data server 104 may recommend that the individual explore alternative methods and/or times of commuting to work (e.g., taking public transportation, going to work earlier when there is less traffic on the road, biking, etc.). In addition, the data server 104 may determine a home security pattern from analyzing the home data 114, which indicates that a break-in occurred recently at the individual's residence. The break-in may be causing the individual to feel especially anxious and insecure, and thus contributing to the increase in the individual's stress level. Consequently, comparison of the determined stress pattern and the home security pattern reveals that the individual's apprehensiveness regarding the safety of his or her home may be another possible underlying factor for the individual's increased stress. Based on this correlation, the data server 104 may recommend that the individual upgrade his or her home security system or install extra security measures around the house in order to give the individual better peace of mind.

Aside from offering information and recommendations, the data server 104 may also offer the individual with goods or services (or indications of goods or services) that may be of interest or value to the individual. In some embodiments, the data server 104 may provide the individual with discounts on insurance products (e.g., vehicle, home, life, health, etc.) when the individual consents to have the data server 104 collect and process various types of data associated with the individual, and the data server 104 determines that meaningful correlations exist within those collected data. In other embodiments, the data server 104 may offer the individual added value, such as targeted offers with local or national merchants, based on the determination of underlying factors and meaningful correlations in the various types of data collected from the individual. In still other embodiments, based on the determined underlying factors and correlations, the data server 104 may offer the individual with other added values or services such as coupons, rewards, membership subscriptions, discounts on products and services, means for home or vehicle automation, tutorial programs, etc. These added value offers may be communicated and displayed to the individual via the user interfaces 112 (e.g., a display panel) of the computing device 102, for example.

In various embodiments, the data server 104 may be configured to allow the individual to view and track various information associated with the aggregated home data 114, the vehicle data 116 and the personal health data 118. For example, the data server 104 may extract information from the individual's vehicle data 116 (e.g., total miles driven, gas mileage, carbon footprint of the vehicle, etc.), and allow the individual to view and track that information. This helps the individual to keep track of the vehicle condition, as well as the individual's own driving habits. Further, based on the extracted information, the data server 104 may also provide helpful periodic alerts to the individual such as service reminders for oil changes, updates on insurance premiums, etc. Likewise, the data server 104 may extract and display various information from the home data 114 (e.g., utility usage, home improvement needs, etc.) and the personal health data 118 (e.g., fitness level, medical history, etc.). By allowing the individual to view and track these information, the data server 104 provides additional support for the individual to better manage and improve the various aspects of his or her life.

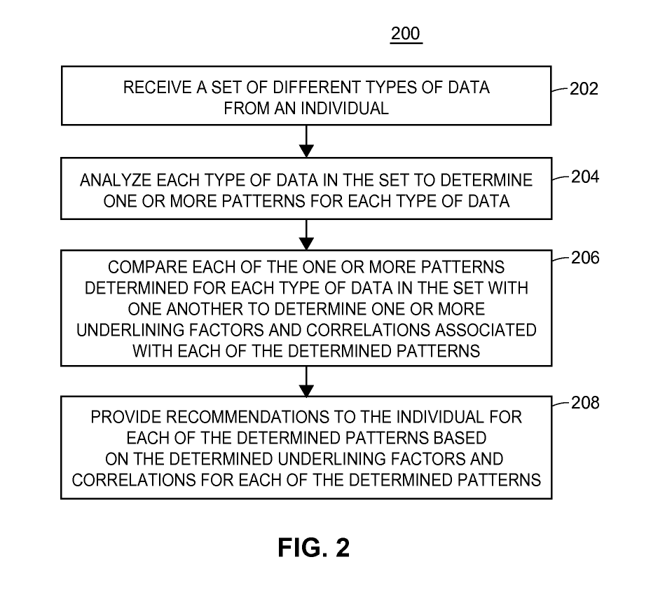

Referring now to FIG. 2, which describes a flow diagram of an example method 200 for aggregating and correlating various types of data from an individual for life management purposes. The method 200 may include one or more blocks, routines or functions in the form of computer executable instructions that are stored in a tangible computer-readable medium (e.g., 104B of FIG. 1) and executed using a processor (e.g., 104A of FIG. 1).

The method 200 begins by receiving a set of different types of data from an individual (block 202). For example, the method 200 may receive a set of home data, vehicle data and personal health data related to the individual. Further, the set of data may include other types of data associated with the individual such as finance data, personal calendar data, online activity data, etc.

Next, the method 200 analyzes each type of data in the set to determine one or more patterns associated with each type of data (block 204). For example, the method 200 may analyze and determine one or multiple patterns associated with each data type in the set of home data, vehicle data and personal health data.

The method 200 then compares each of the one or more patterns determined for each type of data in the set with one another in order to determine one or more underlying factors and correlations associated with each of the determined patterns (block 206). For example, in the set of home data, vehicle data and personal health data, the method 200 may compare a pattern determined for the home data to all other patterns determined for the vehicle data and the personal health data. By comparing the patterns to each other, the method 200 may discover meaningful underlying factors and correlations between them.

Finally, the method 200 provides recommendations and/or other useful information to the individual for each of the determined patterns based on the determined underlying factors and correlations for each of the determined patterns (block 208).

The blocks 202 to 208 may be repeated multiple times. For example, the method 200 may receive various types of data from the individual on a regular basis (e.g., at various times during each week, month, year) for continuous life management purposes.

Using the system (e.g., 100) and method (e.g., 200) described herein, a system may be implemented for aggregating and correlating various types of data from an individual for the purpose of managing and improving the individual's life.

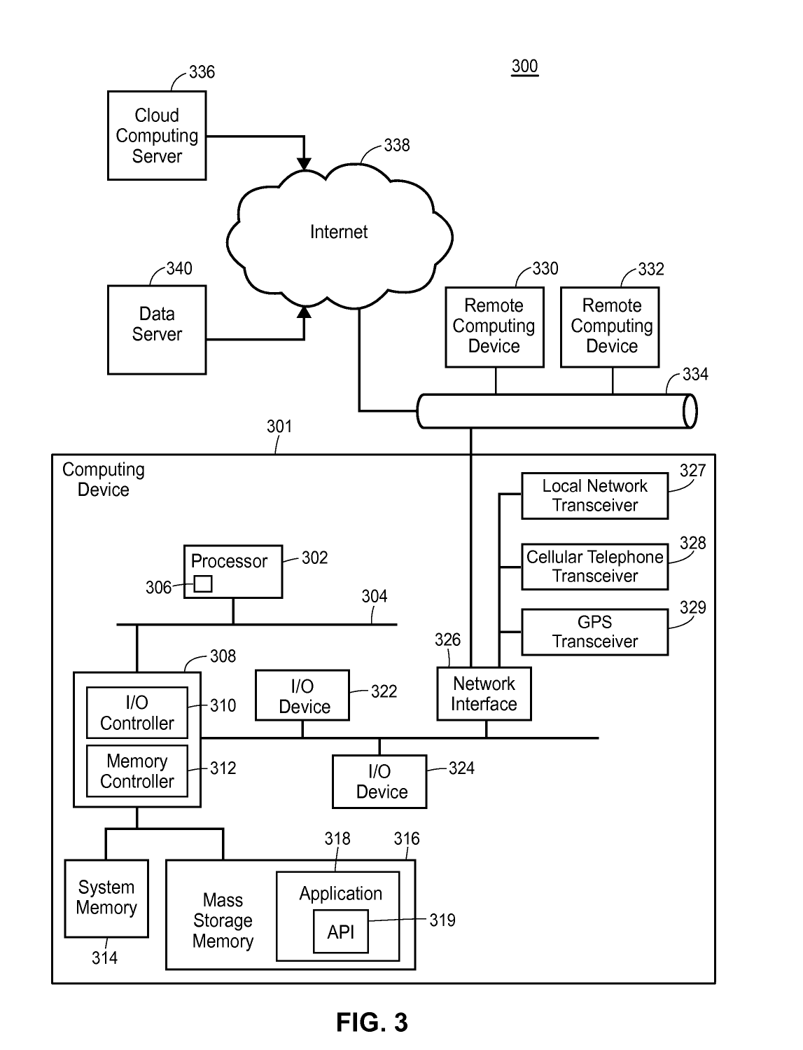

FIG. 3 is a block diagram of an example computing environment for a system 300 having a computing device 301 that may be used to implement the systems and methods described herein. The computing device 301 may include one or more computing devices 102, a data server 104, a mobile computing device (e.g., cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example system 300 may be used to implement and execute the example system of FIG. 1, the method of FIG. 2, and the like. Although the example system 300 is described below as including a plurality of peripherals, interfaces, chips, memories, etc., one or more of those elements may be omitted from other example processor systems used to implement and execute the example system 100. Also, other components may be added.

As shown in FIG. 3, the computing device 301 includes a processor 302 that is coupled to an interconnection bus 304. The processor 302 includes a register set or register space 306, which is depicted in FIG. 3 as being entirely on-chip, but which could alternatively be located entirely or partially off-chip and directly coupled to the processor 302 via dedicated electrical connections and/or via the interconnection bus 304. The processor 302 may be any suitable processor, processing unit or microprocessor. Although not shown in FIG. 3, the computing device 301 may be a multi-processor device and, thus, may include one or more additional processors that are identical or similar to the processor 302 and that are communicatively coupled to the interconnection bus 304.

The processor 302 of FIG. 3 is coupled to a chipset 308, which includes a memory controller 310 and a peripheral input/output (I/O) controller 312. As is well known, a chipset typically provides I/O and memory management functions as well as a plurality of general purpose and/or special purpose registers, timers, etc. that are accessible or used by one or more processors coupled to the chipset 308. The memory controller 310 performs functions that enable the processor 302 (or processors if there are multiple processors) to access a system memory 314 and a mass storage memory 316, that may include either or both of an in-memory cache (e.g., a cache within the memory 314) or an on-disk cache (e.g., a cache within the mass storage memory 316).

The system memory 314 may include any desired type of volatile and/or non-volatile memory such as, for example, static random access memory (SRAM), dynamic random access memory (DRAM), flash memory, read-only memory (ROM), etc. The mass storage memory 316 may include any desired type of mass storage device. For example, if the computing device 301 is used to implement an application 318 having an API 319 (including functions and instructions as described by the method 200 of FIG. 2). The mass storage memory 316 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 301 and the system 300. Thus, a module, block, function, operation, procedure, routine, step, and method can be implemented in hardware, firmware, and/or software. In one embodiment, program modules and routines (e.g., the application 318, the API 319, etc.) are stored in mass storage memory 316, loaded into system memory 314, and executed by a processor 302 or can be provided from computer program products that are stored in tangible computer-readable storage mediums (e.g., RAM, hard disk, optical/magnetic media, etc.).

The peripheral I/O controller 310 performs functions that enable the processor 302 to communicate with peripheral input/output (I/O) devices 322 and 324, a network interface 326, a local network transceiver 327, a cellular network transceiver 328, and a GPS transceiver 329 via the network interface 326. The I/O devices 322 and 324 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The cellular telephone transceiver 328 may be resident with the local network transceiver 327. The local network transceiver 327 may include support for a Wi-Fi network, Bluetooth, Infrared, or other wireless data transmission protocols. In other embodiments, one element may simultaneously support each of the various wireless protocols employed by the computing device 301. For example, a software-defined radio may be able to support multiple protocols via downloadable instructions. In operation, the computing device 301 may be able to periodically poll for visible wireless network transmitters (both cellular and local network) on a periodic basis. Such polling may be possible even while normal wireless traffic is being supported on the computing device 301. The network interface 326 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 312 and the I/O controller 310 are depicted in FIG. 3 as separate functional blocks within the chipset 308, the functions performed by these blocks may be integrated within a single integrated circuit or may be implemented using two or more separate integrated circuits. The system 300 may also implement the application 318 on remote computing devices 330 and 332. The remote computing devices 330 and 332 may communicate with the computing device 301 over an Ethernet link 334. For example, the computing device 301 may receive home data, vehicle data and personal health data created by an application executing on a remote computing device 330, 332. In some embodiments, the application 318 may be retrieved by the computing device 301 from a cloud computing server 336 via the Internet 338. When using the cloud computing server 336, the retrieved application 318 may be programmatically linked with the computing device 301. The application 318 may be a Java® applet executing within a Java® Virtual Machine (JVM) environment resident in the computing device 301 or the remote computing devices 330, 332. The application 318 may also be “plug-ins” adapted to execute in a web-browser located on the computing devices 301, 330, and 332. In some embodiments, the application 318 may communicate with a backend component 340 such as the data server 104 via the Internet 338.

The system 300 may include but is not limited to any combination of a LAN, a MAN, a WAN, a mobile, a wired or wireless network, a private network, or a virtual private network. Moreover, while only two remote computing devices 330 and 332 are illustrated in FIG. 3 to simplify and clarify the description, it is understood that any number of client computers are supported and can be in communication within the system 300.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” means that a particular element, feature, structure, or characteristic described in connection with the embodiment is included in at least one embodiment. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depicting preferred embodiments of a system for aggregating and correlating various types of data from an individual for life management purposes are for illustration purposes only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for aggregating and correlating various types of data from an individual for life management purposes through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method of aggregating and correlating data, the method comprising:
receiving, via one or more processors, a set of data from an individual wherein the set of data includes at least two different types of data selected from the group of data types consisting essentially of: home data, vehicle data, personal health data and finance data;
analyzing, via one or more processors, the set of data to determine patterns for each type of data in the set;
correlating, via one or more processors, each of the determined patterns for each type of data in the set with one another to determine one or more underlying factors associated with each of the determined patterns; and
providing, via one or more processors, recommendations to the individual for each of the determined patterns based on the determined one or more underlying factors associated with each of the determined patterns.

2. The computer-implemented method of claim 1, wherein analyzing each type of data in the set to determine patterns includes analyzing the home data to determine one or more home patterns, the one or more home patterns including patterns associated with physical conditions of a home, environmental and security settings of a home, energy or utility usages in a home, or control and automation of a home.

3. The computer-implemented method of claim 1, wherein analyzing each type of data in the set to determine patterns includes analyzing the vehicle data to determine one or more vehicle patterns, the one or more vehicle patterns including patterns associated with physical conditions of a vehicle, usage of a vehicle, physical and mental conditions of a driver of a vehicle, driving environments, or a driver's interactions with a vehicle.

4. The computer-implemented method of claim 1, wherein analyzing each type of data in the set to determine patterns includes analyzing the personal health data to determine one or more personal health patterns, the one or more personal health patterns including patterns associated with physiological parameters of an individual including a heart rate, a blood pressure, a sleep pattern, a stress level, or a body weight, or fitness activities carried out by an individual including walking, running, biking, swimming or weight training.

5. (canceled)

6. The computer-implemented method of claim 1, further comprising:
extracting, via one or more processors, information associated with each type of data in the set; and
displaying, via one or more processors, the extracted information associated with each type of data in the set to the individual.

7. The computer-implemented method of claim 1, wherein providing recommendations to the individual for each of the determined patterns includes providing one or more of a reward, an alert, a coupon, a membership subscription, an insurance discount, a discount on goods and services, a means for home or vehicle automation, or a tutorial program.

8. The computer-implemented method of claim 1, further comprising displaying the recommendations to the individual.

9. A non-transitory computer-readable storage medium including computer-readable instructions to be executed on one or more processors of a system for aggregating and correlating data from an individual, the instructions when executed causing the one or more processors to:
receive a set of data from the individual wherein the set of data includes at least two different types of data selected from the group of data types consisting essential of: home data, vehicle data, personal health data and finance data;
analyze the set of data to determine patterns for each type of data in the set;
correlate each of the determined patterns for each type of data in the set with one another to determine one or more underlying factors associated with each of the determined patterns; and
provide recommendations to the individual for each of the determined patterns based on the determined one or more underlying factors associated with each of the determined patterns.

10. The non-transitory computer-readable storage medium of claim 9, further including instructions that, when executed, cause the one or more processors to extract information associated with each type of data in the set; and display the extracted information associated with each type of data in the set to the individual.

11. The non-transitory computer-readable storage medium of claim 9, wherein the instructions to provide recommendations to the individual for each of the determined patterns include providing one or more of a reward, an alert, a coupon, a membership subscription, an insurance discount, a discount on goods and services, a means for home or vehicle automation, or a tutorial program.

12. The non-transitory computer-readable storage medium of claim 9, further including instructions that, when executed, cause the one or more processors to display the recommendations to the individual.

13. A computer system for aggregating and correlating data from an individual, the system comprising:
a plurality of data repositories, each data repository storing a different type of data from the individual;
a data pattern repository; and
a data server, including a memory having instructions for execution on one or more processors, wherein the instructions, when executed by the one or more processors, cause the data server to:
receive a set of data from the plurality of data repositories wherein the set of data includes at least two different types of data selected from the group of data types consisting essentially of: home data, vehicle data, personal health data and finance data;
analyze the set of data to determine patterns for each type of data in the set;
store each of the determined patterns in the data pattern repository;
correlate each of the determined patterns for each type of data in the set with one another to determine one or more underlying factors associated with each of the determined patterns;
provide, via a network connection, recommendations to the individual for each of the determined patterns based on the determined one or more underlying factors associated with each of the determined patterns; and
display, via a network connection, the recommendations to the individual.

14. The computer system of claim 13, wherein the instructions of the data server, when executed by the one or more processors, further cause the data server to extract information associated with each type of data in the set; and display the extracted information associated with each type of data in the set to the individual.
